(19) United States
(12) Patent Application Publication
(10) Pub. No.: US 2013/0160790 A1
(43) Pub. Date: Jun. 27, 2013

(54) Simple dental floss applicator

(71) Applicant: Cho Sing Yap, Raleigh, NC (US)

(72) Inventor: Cho Sing Yap, Raleigh, NC (US)

(21) Appl. No.: 13/374,327

(22) Filed: Dec. 22, 2011

(51) Int. Cl. A61C 15/04

(52) U.S. Cl. 132/324; 132/323; 132/327; 132/321

(57) ABSTRACT

The stem extended from the handle has a slot in the center dividing it into two halves. The ends of two halves branch out to form a ‘Y’ structure and then each extended forwards to form two prongs. Each prong is bent downwards 90 degrees at two thirds of its length with a ‘T’ shaped slit in the tip. The ends of the arms of the ‘Y’ structure are connected by a link. A sliding button holds the new floss and the return floss. With the button in the slot and the floss routed through the guiding rings in the arms of the ‘Y’ structure, under the link, up and over the prongs and through the ‘T’ slits, pulling the button towards the handle creates the tension in the floss, rotating the button feeds new floss across the tips and rewinds the used floss onto the button.

### CROSS-REFERENCE OF RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### BACKGROUND OF THE INVENTION

(a) Field of the Invention

This invention is related to a dental floss applicator for maintaining good dental hygiene.

(b) Description of the Related Art Including Information Disclosed under 37 CFR 1.98 and 37 CFR 1.98

All the related art known so far employs a handle with two prongs at the end. Munro (U.S. Pat. No. 1,627,525) uses the U-handle to control floss tension. Wagner (U.S. Pat. No. 6,047,711) uses a hole in each tip to hold the pellet attached to a section of floss and Yafai (U.S. Pat. No. 4,304,246) uses a loop of floss. The present design uses a sliding button to achieve multiple functions such as the control of floss tension, to store the new floss, to deliver the new floss across the tips of the two prongs, to rail in the used floss and to store it temporarily. It allows a smooth and continuous flossing routine without interruptions as occurred in the previous designs.

### BRIEF DESCRIPTION

The simple floss applicator consists of a handle, a stem, two prongs, a sliding button in the slot of the stem. The slot divides the stem into two halves in its entire length. The ends of the two halves are extended to form the two arms of a ‘Y’ structure. The ends of the two arms are connected by a link. The two ends of the two arms continue to extend to form two prongs. The button holds the new floss in the top section of its mid section and delivers the new floss for use. With the floss routed through the guiding rings in the arms of the ‘Y’ structure, under the link, up and over the prongs, through the ‘T’ slit in the tip of each of the two prongs and finally terminated and attached at the bottom section of the mid section of the button, the applicator is ready for use. Pulling the button towards the handle creates a tension in the floss, rotating the button feeds new floss across the tips and rails in the used floss and temporarily stores it in the bottom section of the mid section for disposal at the of the flossing routine.

### ANNOTATED DRAWING SHEETS

FIG. 1A (canceled)

FIG. 1B (canceled)

FIG. 1C (canceled)

FIG. 2 (canceled)

FIG. 3 (canceled)

FIG. 4A (canceled)

FIG. 4B (canceled)

FIG. 4C (canceled)

FIG. 4D (canceled)

FIG. 4E (canceled)

FIG. 5A (canceled)

FIG. 5B (canceled)

FIG. 5C (canceled)

FIG. 5D (canceled)

FIG. 5E (canceled)

FIG. 6A (canceled)

FIG. 6B (canceled)

FIG. 7 (canceled)

FIG. 8 (canceled)

FIG. 9A (canceled)

FIG. 9B (canceled)

FIG. 9C (canceled)

FIG. 9D (canceled)

FIG. 10A (canceled)

FIG. 10B (canceled)

FIG. 11 (new)

FIG. 12 (new)

FIG. 13 (new)

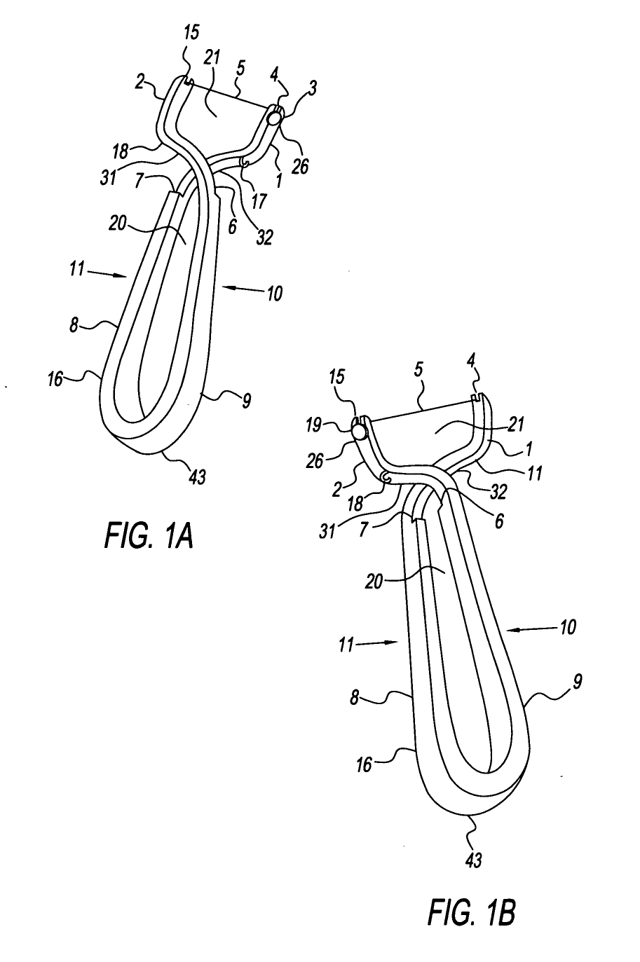

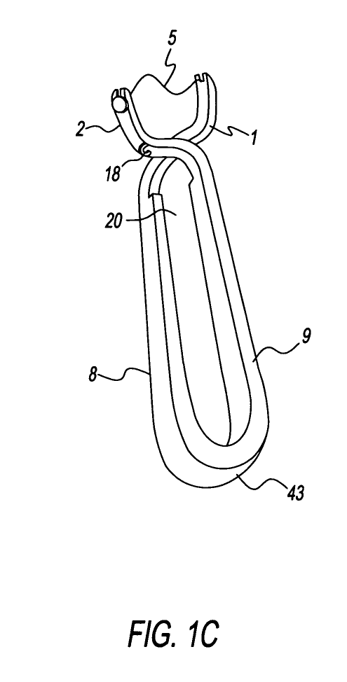

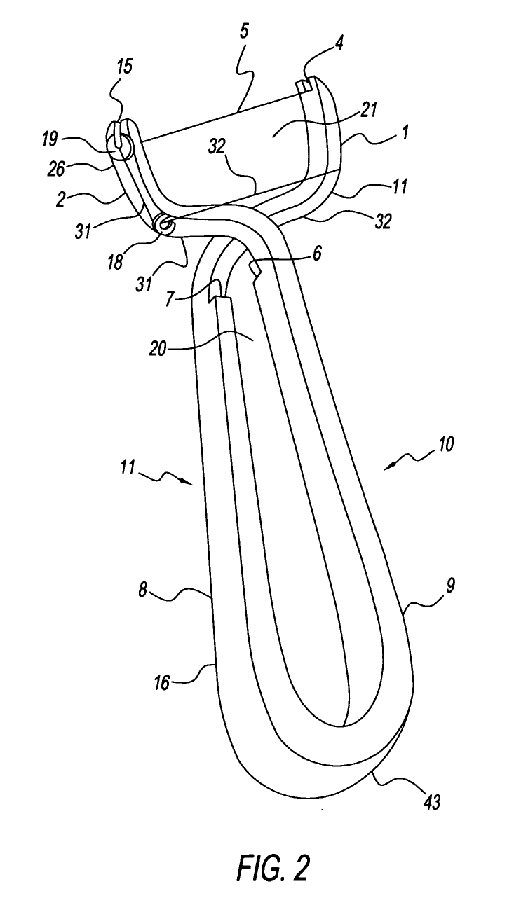

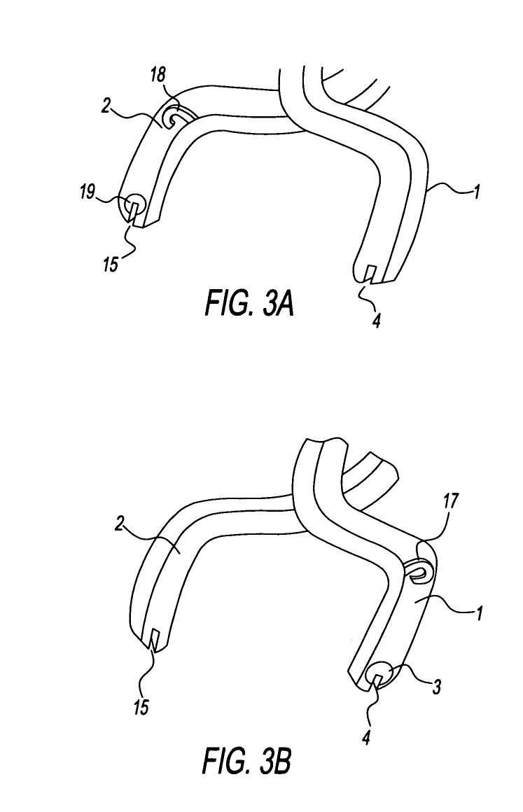

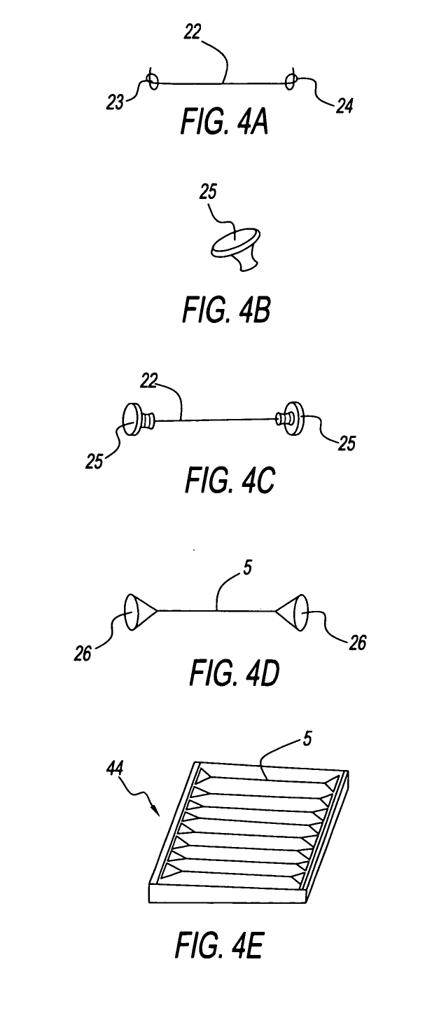

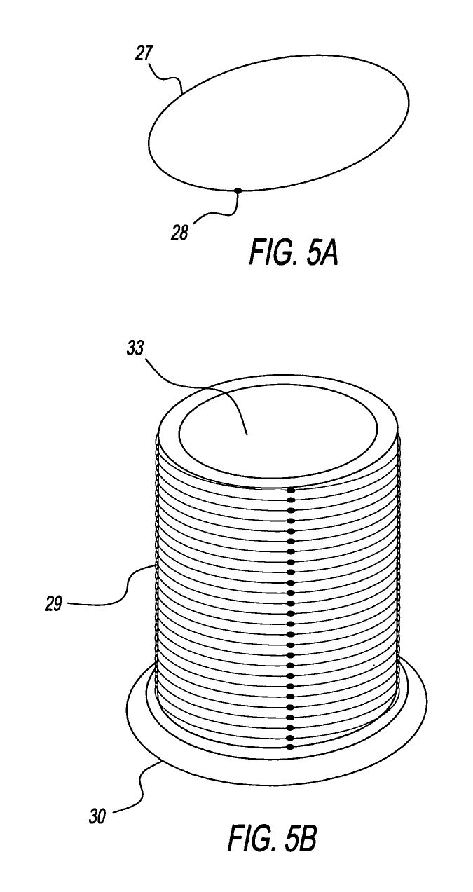

### BRIEF DESCRIPTION OF DRAWINGS

FIG. 11 shows the simple dental floss applicator.

FIG. 12 shows the parts which make up the sliding button.

FIG. 13 shows the floss wound on the top and bottom section of the midsection without the floss cover over the top section.

### DETAILED DESCRIPTION OF DRAWINGS

FIG. 11 shows the simple dental floss applicator with the handle 23. The sliding button 22 can slide in the slot 17 which divides the stem 37 into two halves 18 and 19. The ends 13 and 15 of the two halves branch out to form the two arms 6 and 11 of the ‘Y’ structure 40. The ends 38 and 39 of the two arms 6 and 11 are connected by a link 10 for support. The two ends 38 and 39 are extended to form the two prongs 8 and 7. The prongs 8 and 7 bent downwards 90 degrees at two thirds of their lengths to form the downward sections 4 and 2 each with a ‘T’ shaped slit 3 and 1 in their tips. The new floss 21, 9, and 5 from the top section of the button's midsection is routed through the guiding ring 12 on the inner side and at the lower end of the arm 11 and under the link 10 and over the prong 8 and through the two slits 3 and 1. The used floss 20 is routed over the prong 7, under the link 10, through the guiding ring 16 and back to be wound on the bottom section of the sliding button.

FIG. 12 shows the parts which make up the sliding button 22. The midsection 41 with a screw 28 on its top end and the button bottom 36 are all in one piece. The raised ring 32 divides the midsection into two sections 31 and 34, both have a cut 30 and 35 for attaching floss. Section 31 is much longer than section 34 and is used for storing new floss. Section 34 is used to store the used floss temporarily. 33 is the collar of the ring 32. The screw head 29 and the separating ring 32 have a lager diameter than the midsection's top section 31 and the bottom section 34. The separation ring 32, its collar 33 and the groove 24 on the underneath side of the button top 23 keep the floss cover 26 in place after the screw 28 of the midsection screwed into the screw hole 25 underneath the button top 23. The floss cover 26 has a floss outlet slit 27.

FIG. 13 shows the new floss 21 delivered from the top section 31 of the midsection 41 of the sliding button 22. The used floss 20 is wound on the bottom section 34. The separation ring 32 separates the mid-section 41 into two sections 31 and 34. The button top 23 is larger than the button bottom 36 and the button bottom 36 is larger than the midsection 41. The floss cover 26 for the top section 31 is purposely omitted to show the new floss on the top section.

### DETAILED DESCRIPTION

The simple floss applicator consists of two prongs, a stem with a slot, a sliding button and a handle. The stem is extended from one end of the handle. The slot along the center of the stem divides the entire stem into two halves. The two ends of the divided stem each is extended outwards in opposite direction with an angle to form the two arms of a ‘Y’ structure. The ends of the two arms of the ‘Y’ structure are connected by a link and continue to extend forwards to form two prongs in the direction of the stem but with a small declination angle. Each prong bent downwards 90 degrees at two thirds of its length to form a downward section with a T slit tilted 90 degrees in its tip. The two ‘T’ slits are in line with each other across the space between the two tips. On the inner side and at the lower part of each arm, a ring is used to guide the floss. Each ring has a slit at the edge of the arm on the top side.

The sliding button has a bigger top than its bottom and a small mid section. The button top has a screw hole and a groove on the underneath side to keep the floss cover in place. The mid section has a screw on the top which screw into the screw hole underneath the button top. The mid section is divided into two sections by a raised ring. Each section has a cut for attaching the floss. New floss is attached to the top section and wound onto it until it is full and holds it for use. The top section has a cylindrical cover with a slit for floss outlet. The bottom section holds the return floss. The floss is routed through the two guiding rings in the lower arms of the ‘Y’ structure, under the link, up and over the prong and through the two slits in the two tips and finally is terminated and attached at the cut in the bottom section. Insert the button bottom and its mid section into the space between the two arms of the ‘Y’ structure and slide it into the slot of the stem. The applicator is ready for use.

Pulling the button towards the handle creates a tension in the floss and rotating the button feeds new floss across the tips and rails in the used floss and temporarily winds it onto the bottom section of the button.

1-31. (canceled)

32. The simple dental floss applicator comprising
A stem extended from one end of the handle, a slot in the stem dividing its entire length into two equal halves; the two ends of the divided stem branched out to form the two arms of a ‘Y’ structure with the ends of the arms connected by a link; a guiding ring on the inner side at the lower part of each arm used for floss guide, a narrow slit in each guiding ring at the edge of the arm on the top side;
Two prongs at the front end each extending forwards but slightly down from the ends of the two arms of the ‘Y’ structure; each of the two prongs bent downwards 90 degrees at two thirds of its length to form the downward section of the prong, a ‘T’ slit tilted 90 degrees in its tip of each of the downward section of the prongs for holding and guiding the floss;
A sliding button in the slot of the stem made of two parts, the button top bigger than its bottom and its bottom bigger than its mid section; a circular groove around a screw hole on the underneath side of button top, a circular groove for keeping the floss holder cover in place; a screw at the top of the mid section to screw into the screw hole underneath the button top, the screw head bigger than the mid section in diameter, the mid section divided into two sections by a raised ring, a raised ring with a collar, the longer section or top section used as a floss holder and the shorter section or the bottom section used as a return floss holder; a cut in each section for attaching floss, a cylindrical floss cover with a slit in the center for the longer section; the space between the arms of the ‘Y’ structure bigger than the button bottom to allow the button bottom to go through it and to slide into the slot in the stem;
A suitable length of new floss from the floss holder of the mid section with its end attached to the cut in the short section of the midsection, the floss routed through the rings in the arms, under the link, up and over the prongs and through the ‘T’ slits in the two tips; the button in the slot of the stem pulled towards the handle to create tension in the floss, the button in the slot of the stem rotated to deliver new floss and to rail in the used floss for temporary storing in the bottom section.

33. The slot in the stem extended from one end of the handle as claimed in claim 32 wherein begins from one end of the handle to the entire length of stem dividing it into two equal halves.

34. The end of each of the two divided stem as claimed in claim 32 wherein branches out in opposite direction at a angle to form the two arms of a ‘Y’ structure with the ends of the two arms connected by a link for support.

35. The two prongs at the front end each extended forwards with a small declination angle from the ends of the two arms of the ‘Y’ structure as claimed in claim 32 wherein are parallel to each other and in line with the stem.

36. The two prongs each bent downwards 90 degrees at two thirds of its length to form the downward section of the prong with a ‘T’ shaped slit in its tip as claimed in claim 32 wherein the ‘T’ slit is tilted 90 degrees with the end of the ‘T’ stem pointing to the front in the direction of the stem.

37. The tilted ‘T’ shaped slit in the tip of each of the downward section of the two prongs as claimed in claim 32 wherein are facing each other and in line with each other across the space between the two tips.

38. The guiding ring on the inner side and at the lower end of each of the two arms of the ‘Y’ structure as claimed in claim 32 wherein a slit in the ring is at the edge and on the top side of each arm.

39. The top section or the longer section of the mid section of the sliding button for storing new floss has a cut as claimed in claim 32 wherein the new floss is attaché to the cut and wound around the longer section until it is full.

40. The button bottom and the button midsection with a screw at its top end as claimed in claim 32 wherein are in one piece.

41. The button top and floss cover for the top section of the midsection of the button as claimed in claim 32 and the floss wound on the top section as claimed in claim 39 wherein the floss cover is placed over the top section and screw its screw into the screw hole underneath the button top to complete the button assembly.

42. A suitable length of a floss from the top section of the mid section of the button with its end attached onto the cut in the bottom section of the midsection as claimed in claim 32 wherein is wound around the bottom section a couple of times in the opposite direction to the floss being delivered from the top section.

43. The two arms of the ‘Y’ structure as claimed in claim 32 and the floss in the button mid section as claimed in claims 41 and 42 wherein inserting the button bottom and its mid section into the space between the two arms of the ‘Y’ structure and slide the button into the slot of the stem as claimed in claim 32.

44. The button in the slot of the stem as claimed in claim 43 and the guiding ring in each of the arms of the ‘Y’ structure, the link and the ‘T’ slit in the tip of the downward section of each of the two prongs as claimed in claim 32 wherein routing the floss through the guiding rings, under the link, up and over the prongs and through the ‘T’ slit in the tip of the downward section of each of the prongs, the floss applicator is ready for use.

45. With the sliding button in the slot of the stem as claimed in claim 43 and the floss set up and routed as claimed in claim 44 wherein pulling the button in the slot towards the handle creates a tension in the floss, rotating the button rails in the used floss and store it temporally in the bottom section of the midsection of the button.

46. The separation ring and its collar in the midsection and the groove in the underneath side of the button top and the cylindrical cover for the top section of the midsection as claimed in claim 32 wherein the separation ring, its collar and the groove keep the cover in place.

47. The cylindrical cover with slit in the center as claimed in claim 32 wherein the cover will not rotate with the button when floss is being delivered floss through the slit.

48. The space between the two arms of the ‘Y’ structure being bigger than the button bottom and its midsection as claimed in claim 32 wherein allows the button bottom and the mid section to be inserted into the space and slide into the slot of the stem or to be removed from the slot for cleaning.
